(19) United States
(12) Patent Application Publication
(10) Pub. No.: US 2006/0282647 A1
(43) Pub. Date: Dec. 14, 2006

(54) Parallel processing system

(75) Inventor: Antonius Adrianus Maria Van Wel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/554,604

(22) PCT Filed: Apr. 26, 2004
(86) PCT No.: PCT/IB04/50509

§ 371 Date: Oct. 27, 2005

(30) Foreign Application Priority Data
Apr. 28, 2003 (EP) 03101182.8

(51) Int. Cl. G06F 15/00

(52) U.S. Cl. 712/10

(57) ABSTRACT

The invention is based on the idea to provide a functional unit that is capable of performing not only a simple pass operation but also delayed pass operations, introducing a desired amount of latency. Therefore, a parallel processor is provided, wherein said processor comprises a control means CTR for controlling the processing in said processor, a plurality of passing units PU being adapted to perform a programmable number of pass operations with a programmable latency, and a communication network CN for coupling the control means CTR and said plurality of passing units PU.

### TECHNICAL FIELD

The invention relates to a parallel processing system a method of parallel processing and a compiler program product.

### BACKGROUND ART

Programmable processors are used to transform input data into output data based on program information encoded in instructions. The values of the resulting output data are dependent on the input data, the program information, and on the momentary state of the processor at any given moment in time. In traditional processors this state is composed of temporary data values stored in registers.

The ongoing demand for an increase in high performance computing has led to the introduction of several solutions in which some form of concurrent processing, i.e. parallelism, has been introduced into the processor architecture. Two main concepts have been adopted: the multithreading concept, in which several threads of a program are executed in parallel, and the Very Large Instruction Word (VLIW) concept. In case of a VLIW processor, multiple instructions are packaged into one long instruction, a so-called VLIW instruction. A VLIW processor uses multiple, independent execution units or functional units to execute these multiple instructions in parallel. The processor allows exploiting instruction-level parallelism in programs and thus executing more than one instruction at a time. Due to this form of concurrent processing, the performance of the processor is increased. In order for a software program to run on a VLIW processor, it must be translated into a set of VLIW instructions. The compiler attempts to minimize the time needed to execute the program by optimizing parallelism. The compiler combines instructions into a VLIW instruction under the constraint that the instructions assigned to a single VLIW instruction can be executed in parallel and under data dependency constraints.

To control the operations in the data pipeline of a processor, two different mechanisms are commonly used in computer architecture: data-stationary and time-stationary encoding, as disclosed in “Embedded software in real-time signal processing systems: design technologies”, G. Goossens, J. van Praet, D. Lanneer, W. Geurts, A. Kifli, C. Liem and P. Paulin, Proceedings of the IEEE, vol. 85, no. 3, March 1997. In the case of data-stationary encoding, every instruction that is part of the processor's instruction-set controls a complete sequence of operations that have to be executed on a specific data item, as it traverses the data pipeline. Once the instruction has been fetched from program memory and decoded, the processor controller hardware will make sure that the composing operations are executed in the correct machine cycle. In the case of time-stationary coding, every instruction that is part of the processor's instruction-set controls a complete set of operations that have to be executed in a single machine cycle. Instructions are encoded such that they contain all information that is necessary at a given moment in time for the processor to perform its actions. These operations may be applied to several different data items traversing the data pipeline. In this case it is the responsibility of the programmer or compiler to set up and maintain the data pipeline. The resulting pipeline schedule is fully visible in the machine code program. Time-stationary encoding is often used in application-specific processors, since it saves the overhead of hardware necessary for delaying the control information present in the instructions, at the expense of larger code size.

The encoding of parallel instructions in a VLIW instruction leads to a severe increase of the code size. Large code size leads to an increase in program memory cost both in terms of required memory size and in terms of required memory bandwidth.

### DISCLOSURE OF THE INVENTION

It is therefore an object of the invention to reduce the code size for parallel processors.

This object is solved by a parallel processing system according to claim 1, by a method of parallel processing according to claim 6 and a compiler program product according to claim 7.

The invention is based on the idea to provide a functional unit that is capable of performing not only a simple pass operation but also delayed pass operations, introducing a desired amount of latency.

Therefore, a parallel processor is provided, wherein said processor comprises a control means CTR for controlling the processing in said processor, a plurality of passing units PU being adapted to perform a programmable number of pass operations with a programmable latency, and a communication network CN for coupling the control means CTR and said plurality of passing units PU.

According to the invention, a configurable pass unit is realised, whereby the amount of encapsulated functional units for performing passing operations—and therefore the required resources—are reduced. Furthermore, the controller overhead and the instruction word can be reduced. The usage of a programmable pass unit increases the flexibility of the architecture.

According to an aspect of the invention, each of said passing units PU comprises a first functional unit PU. The first functional unit is capable of providing a programmable delay of input data.

According to a further aspect of the invention, each of said first functional units PU comprise a register with a predetermined number of register fields, and a multiplexer MP, which is coupled to an input of said first functional unit PU for receiving input data and which is coupled to said control means CTR via said communication network CN for receiving control instruction from said control means CTR. Said multiplexer MP passes incoming data to one of the register fields according to said control instructions received from said control means CTR. Hence, the introduced delay is dependent on the selected register field, since the time which is needed by the input data to pass through the respective register fields, will depend on the selected register field.

According to another aspect of the invention each of said passing units PU comprises a plurality of functional units L0, L1, L2 grouped together in one issue slot, wherein each functional unit L0, L1, L2 is adapted to perform a pass operation with a predetermined latency. The input data will be passed to one of the functional units L0, L1, L2 according to the required delay or latency as indicated by the instruction code.

According to a further aspect of the invention said processor is implemented as a Very Large Instruction Word processor.

Other aspects of the invention are described in the dependent claims.

### BRIEF DESCRIPTION OF THE DRAWING

The invention will now be described with reference to the drawings, in which:

FIG. 1 shows a schematic block diagram of a basic architecture according to the invention,

FIG. 2 shows a schematic block diagram of a pass unit according to a first embodiment of the invention,

FIG. 3 shows a schematic block diagram of a pass unit according to a second embodiment of the invention,

FIG. 4 shows a dataflow graph of a first code fragment,

FIG. 5 shows a schedule of the first code fragment according to FIG. 4,

FIG. 6 shows an improved schedule of the first code fragment according to FIG. 4,

FIG. 7 shows a dataflow graph of a second code fragment,

FIG. 8 shows a schedule of the second code fragment according to FIG. 7,

FIG. 9 shows a schedule of two cycles of the second code fragment according to FIG. 7,

FIG. 10 shows a dataflow graph of a third code fragment based on the second code fragment according to FIG. 7,

FIG. 11 shows a schedule of the third code fragment according to FIG. 10,

FIG. 12 shows a further schedule of the third code fragment according to FIG. 10,

FIG. 13 shows a further improved schedule of the third code fragment according to FIG. 10,

FIG. 14 shows a dataflow graph of a fourth code fragment,

FIG. 15 shows a schedule of the fourth code fragment according to FIG. 14,

FIG. 16 shows an improved schedule of the fourth code fragment according to FIG. 14,

FIG. 17 shows a dataflow graph of a fifth code fragment based on the fourth code fragment according to FIG. 14,

FIG. 18 shows a schedule of the fifth code fragment according to FIG. 17, and

FIGS. 19-22 show some dataflow graphs to illustrate pass operations with multiple latencies.

### DESCRIPTION OF PREFERRED EMBODIMENTS

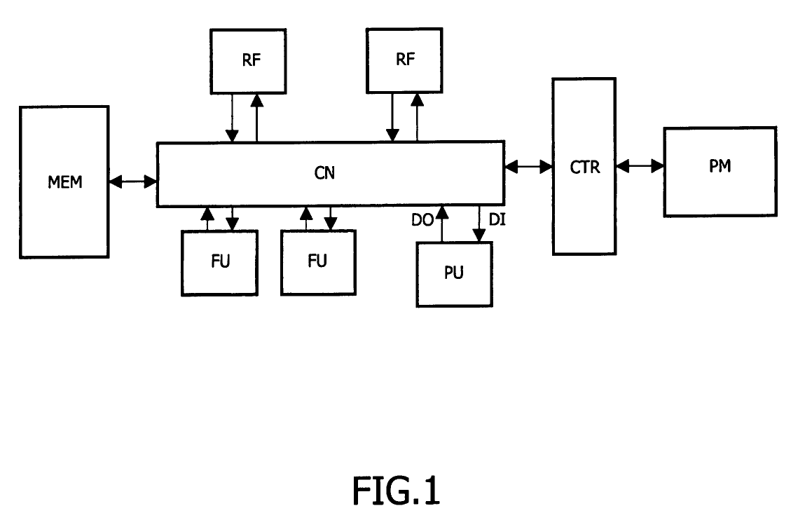

FIG. 1 shows a schematic block diagram of a basic architecture according to the invention. The architecture comprises a program memory PM, a control means CTR, a memory MEM, a plurality of functional units FU (only two are shown), a plurality of register files RF (only two are shown), a passing unit and a communication network CN. The communication network CN connects the register files RF, the passing units PU, the functional units FU, the memory MEM and the control means CTR with each other. The controller CTR is further more connected to the program memory PM and retrieves instructions from an address in the program memory PM and forwards the respective instructions to the functional units FU and the passing units PU. The passing unit PU has a data input DI and a data output DO. The functional units FU may be any kind of functional units like execution units, arithmetic logic units (ALU) or the like. The memory MEM is used to store data that may be needed by several functional units FU. The register files RF may be implemented as a single central register or as distributed registers.

Although only one single passing unit PU is shown in FIG. 1, it is also possible to incorporate more than one passing unit PU.

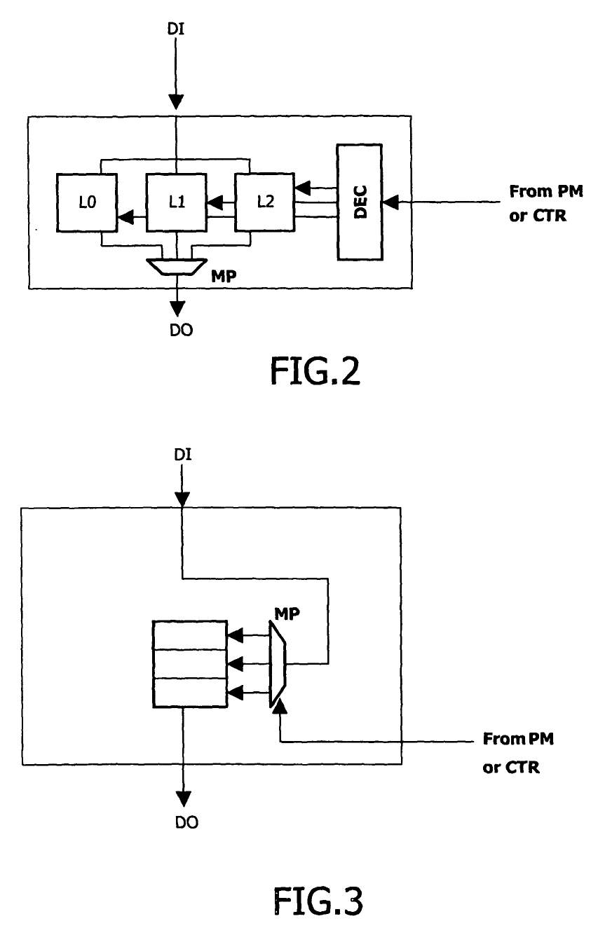

FIG. 2 shows a schematic block diagram of a pass unit according to a first embodiment of the invention. The passing unit PU comprises three functional units L0, L1, L2, a multiplexer MP and a decoder DEC. Furthermore, it has a data input DI and a data output DO. The decoder DEC is coupled to all three functional units L0, L1, L2, which are coupled with its input side to the data input DI and with its output side to the multiplexer MP. The output of the multiplexer MP form the data output DO. The three functional units are grouped together in one issue slot, wherein each unit supports a different operation, i.e. unit L0 supports a pass operation without latency, unit L1 supports a pass operation with latency of 1 and unit L2 supports a pass operation with latency of 2 cycles. The functional unit L1 and L2 may be implemented by 2 and 3 register fields, respectively, with the functional units acting as FIFO's. According the instructions received from the program memory PM or the controller CTR the decoder DEC activates one of the functional units L0, L1, L2 and the input data is consumed by the selected unit and the same value is produces directly at its output without latency in the case of the functional unit L0, one cycle later in the case of the functional unit L1 and two cycles later in the case of functional unit L2, whereby a latency is introduced to the input data. Although the pass unit is described with three functional units any other number of functional units may be used. The decoder DEC and the multiplexer MP must then be adapted to the new number.

FIG. 3 shows a schematic block diagram of a pass unit according to a second embodiment of the invention. The pass unit PU comprises a multiplexer MP and a register with three register fields. The pass unit PU has a data input DI and a data output DO and can be furthermore connected to the program memory PM or the control means CTR. In contrast to the pass unit according to the first embodiment, the unit is now implemented as a single functional resource or functional unit. The pass unit support three pass operations with latencies 0, 1, and 2 respectively. The latencies are realised internally by introducing a delay line for example with register fields. The element or register field that forms the end of the delay line represents the data output DO of the pass unit. Three different pass operations are possible within this pass unit, namely pass_LO, pass_L1, and pass L_2. The “pass_L0” operation writes directly into this last element or register field, introducing no latency. The “pass_L1” operation writes into the second last element, introducing a latency of 1. The “pass_L2” operation writes into the third last element, introducing a latency of 1. Although the pass unit is described with three pass operations any other number of pass operations may be used by adapting the number of register fields and the multiplexer accordingly.

The pass unit according to the second embodiment is simpler and more efficient with regards to the required hardware than the pass unit according to the first embodiment, which is additionally more expensive with regards to area requirements.

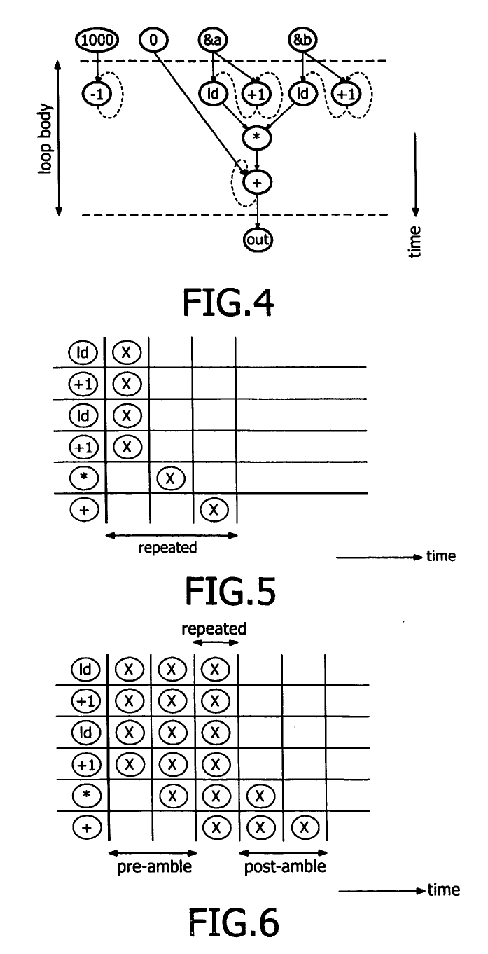

FIG. 4 shows a dataflow graph, wherein the dashed arrows are feedback arrows crossing iterations of the loop; when the output is produced, it is consumed in the next iteration. The dataflow graph corresponds to the following code fragment.

```
int a[1000], b[1000];
int i0 = 0, i1 = 0;
int sum = 0;
int out;
for (int i=1000; i!=0; i−−) {
    sum += a[i0] * b[i1];
    i0++; i1++;
}
out = sum;
```

Two variables ‘a’ and ‘b’ are introduced. The loop indices i0, i1 as well as the variable ‘sum’ are set to zero. The variable ‘out’ represents the output of this operation. A loop starting from 1000 and decrementing step by step is defined. The value of ‘sum’ equals the multiplication of ‘a’ and ‘b’ with i0 and i1 as indices. Then i0, i1 are incremented and the multiplication is performed again, wherein the results of the multiplications are added to the previous results until the loop has been performed 1000 times. The overall summation is the output as variable ‘out’.

If there are sufficient resources available in the processor, the loop body sum +=a[i0]*b[i1] and the i0++; i1++, i.e. the increment, can be encoded as a single instruction which is executed 1000 times.

FIG. 5 shows a schedule of the first code fragment according to FIG. 4. ‘Id’ represents a load operation, ‘+1’ an increment operation, ‘*’ a multiplication operation, and ‘+’ a summation operation. It is assumed that there are at least 6 issue slots, resources or functional units in the processor architecture, each one capable of executing operations, i.e. being separately controllable, preferably in parallel. A cross marks the execution of such an operation on its resource in a certain time slot. Accordingly, can be seen that this loop takes 3 cycles per iteration to execute. What also can be seen, is that only one third of the schedule is actually filled by operations.

FIG. 6 shows an improved schedule of the first code fragment according to FIG. 4. By applying a technique called loop folding or software pipelining, a more efficient schedule can be obtained. The main idea is to repeat the operation as soon as possible, i.e. as soon as a time slot is available on the resource or functional unit.

Compiler technology allows us to map source code on processors. Source codes typically contains many loops. Loops are mapped onto our processors using a technique called loop folding (also known as software pipelining). Ideally, on our processors, these loops are ”folded” into a single instruction. This results in some initialisation code for the loop (pre-amble), the loop body itself (a single instruction), and some clean-up code (post-amble). Pre- and post-amble are executed only once, the loop body is executed repeatedly. The resulting loop body consists of only one instruction. Therefore each iteration takes only 1 cycle to execute.

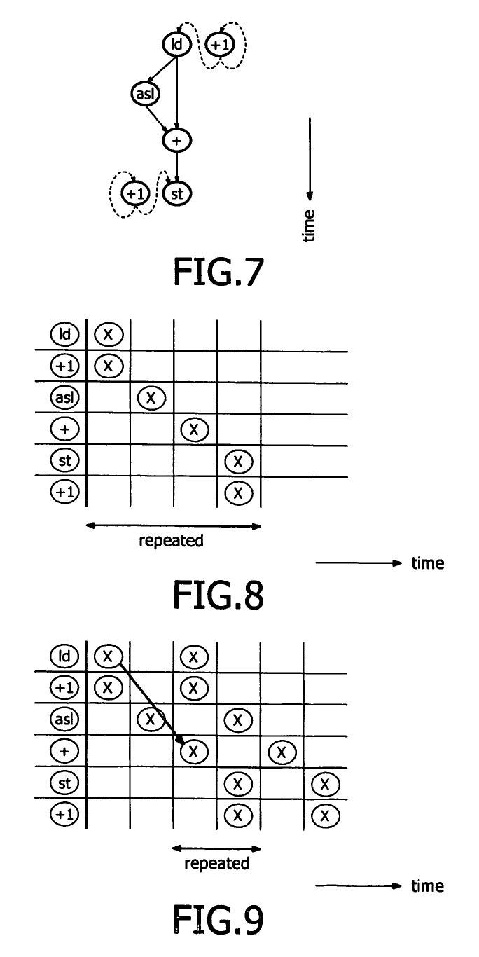

FIG. 7 shows a different dataflow graph of a second code fragment. The graph corresponds to the loop in the following code fragment.

```
int a[1000], b[1000];
int i0 = 0, i1 = 0;
for (int i=1000; i!=0; i−−) {
    int tmp = a[i0];
    b[i1] = (tmp << 1) + tmp;
    i0++; i1++;
}
```

A new variable ‘tmp’ is introduced. The loop index variable and the initialisation of several variables have been omitted, since they are not relevant for the discussion. ‘asl’ represents an asymmetric shift left operation and ‘st’ a store operation. The variable b(i1) represents the sum of a variable ‘tmp’ and the result of an asymmetric shift left operation (tmp<<1) on tmp.

FIG. 8 shows a schedule of the second code fragment according to FIG. 7. The scheduling is straightforward and results into a loop with 4 cycles per itaration.

FIG. 9 shows a schedule of two cycles of the second code fragment according to FIG. 7. Because of the lifetime of variable ‘tmp’, i.e. 2 cycles, the loop cannot be folded into less than 2 cycles.

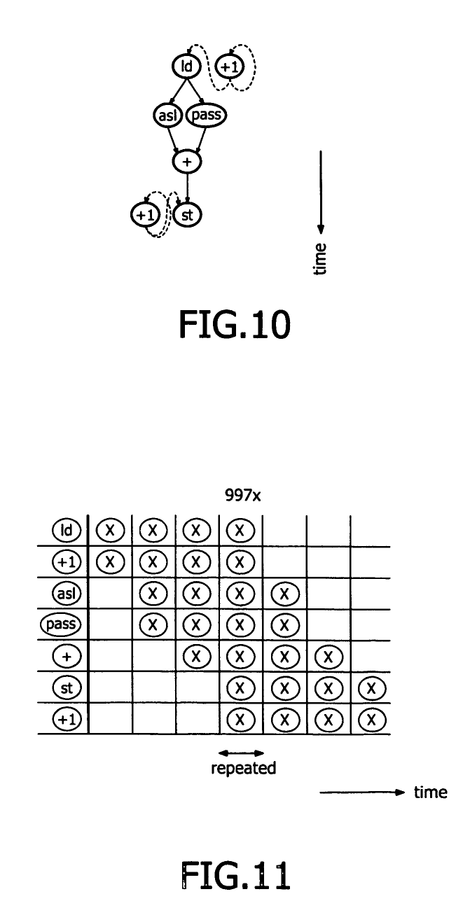

FIG. 10 shows a dataflow graph of a third code fragment based on the second code fragment according to FIG. 7. To improve performance of the code fragment and schedule according to FIG. 7, a new operation is introduced. Instead of directly using variable tmp, we add a pass or copy operation. The lifetime problem has disappeared from the resulting loop folded schedule.

```
int a[1000], b[1000];
int i0 = 0, i1 = 0;
for (int i=1000; i!=0; i−−) {
    int tmp = a[i0];
    b[i1] = (tmp << 1) + pass (tmp);
    i0++; i1++;
}
```

The resulting schedule is shown in FIG. 11. Note that the single instruction loop is repeated 997 times. The remaining 3 iterations are covered by the pre- and post-amble. Therefore by introducing pass operations the performance in loops may improve.

However, the pre-amble and post-amble are dominating the code size of the folded schedules so far. In practice, matters may be even worse since architectures may require pipelined operations; for instance, a “store” operation may take 2 cycles to complete. This can easily result in pre- and post-ambles of 8 instructions each.

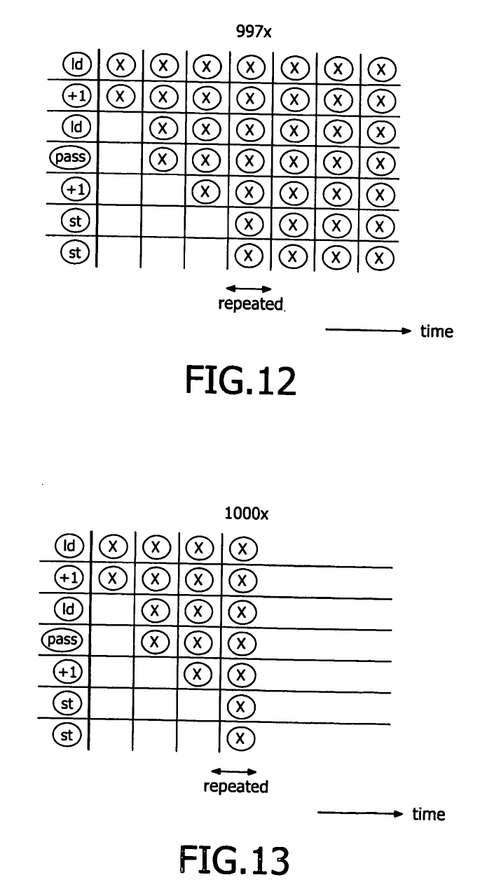

FIG. 12 shows a further schedule of the third code fragment according to FIG. 10. Here, operations have been duplicated to completely fill the post-amble. Since the results of these extra operations are never used, they cannot change the outcome of this schedule. This results into a code size of 7 cycles.

FIG. 13 shows a further improved schedule of the third code fragment according to FIG. 10. The next step to improve the loop performance is to actually merge the operations from the post-amble with the loop body itself. Then the loop may be repeated 1000 times. Hence, the code size has been reduced from 7 to 4 cycles.

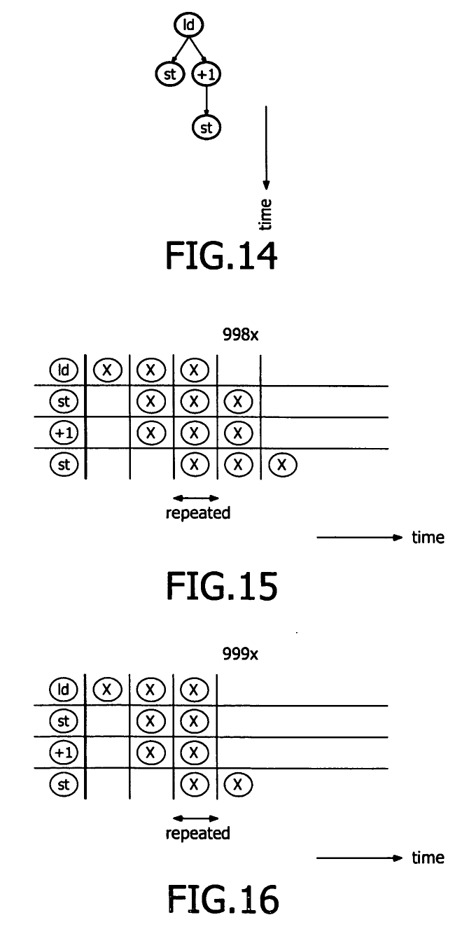

FIG. 14 shows a dataflow graph of a fourth code fragment representing another example. The dataflow graph corresponds to the loop in the following code fragment. More irrelevant details from the dataflow graph have been omitted.

```
int a[1000], b[1000], c[1000];
int i0 = 0, i1 = 0, i2 = 0;
for (int i=1000; i!=0; i−−) {
    int tmp = a[i0];
    b[i1] = tmp;
    c[i2] = tmp + 1;
    i0++; i1++; i2++;
}
```

The variable ‘a’, ‘b’, and ‘c’ as well as the loop variables i0, i1, and i2 are defined. Furthermore, the variable ‘tmp’ corresponds to the value of a(i0), b(i1) corresponds to the value of ‘tmp’ and c(i2) corresponds to the values of ‘tmp’ plus 1.

FIG. 15 shows a schedule of the fourth code fragment according to FIG. 14. The corresponding schedule of the dataflow graph and code fragment including the loop folding results into a code size of 5 cycles, i.e. the first 2 cycles being the pre-amble, than one cycle which is repeated 998 times and two cycles post-amble.

Accordingly, the pre-amble and the post-amble are merely performed once, while the loop body is iterated 998 times.

FIG. 16 shows the result of applying the technique we explained in FIGS. 12 and 13 to FIG. 14. In particular FIG. 16 shows an improved schedule of the fourth code fragment according to FIG. 14. The reducing the post-amble is not as effective as in the previous example. Merely an improvement of a single instruction is achieved. This is caused by the first “store” operation. If this operation would have been scheduled later, the code size could be further reduced.

Sometimes additional operations need to be inserted into the code to be able to map a loop into a single instruction loop.

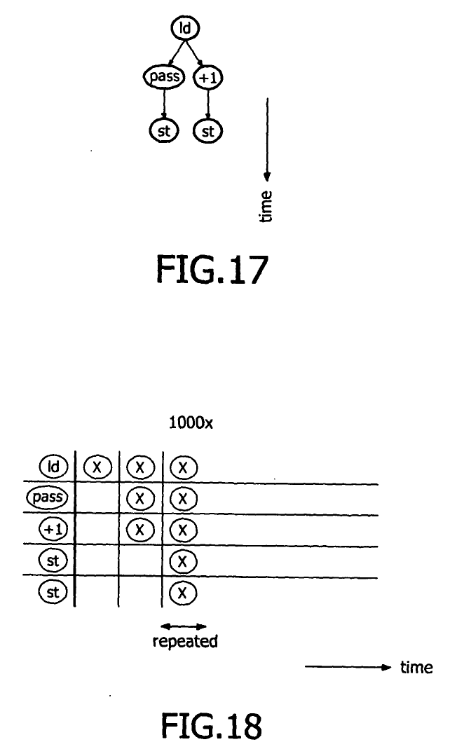

FIG. 16 and intermediate FIG. 15 show exactly where a problem emerges, which is then solved according to FIGS. 17 and 18.

FIG. 17 shows a dataflow graph of a fifth code fragment based on the fourth code fragment according to FIG. 14. The only difference is the introduction of a pass operation. The following code fragment corresponds the data flow graph of FIG. 17.

```
int a[1000], b[1000], c[1000];
int i0 = 0, i1 = 0, i2 = 0;
for (int i=1000; i!=0; i−−) {
    int tmp = a[i0];
    b[i1] = pass (tmp);
    c[i2] = tmp + 1;
    i0++; i1++; i2++;
}
```

The only difference in the code fragment is that b(i1) equals now the result of a pass operation on the variable tmp.

FIG. 18 shows a schedule of the fifth code fragment according to FIG. 17. By introducing the pass operation and whereby introducing a latency of one, the two store operations can be performed within the same cycle. Hence, after loop folding, the post-amble can be completely discarded and the code size is reduced to 3 cycles.

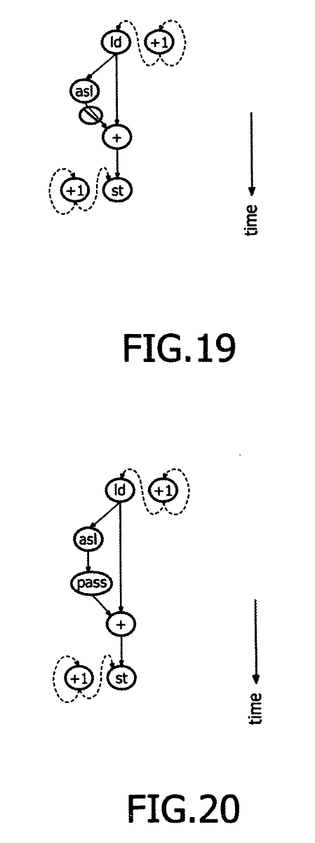

FIG. 19 shows a dataflow graph based on the dataflow graph of FIG. 7. For the case when there is no direct connection between the output of a resource supporting the ‘asl’ operation and the input of a resources supporting the add operation, then instead a resource, which supports a “pass” operation, must be provided in between them and connecting them.

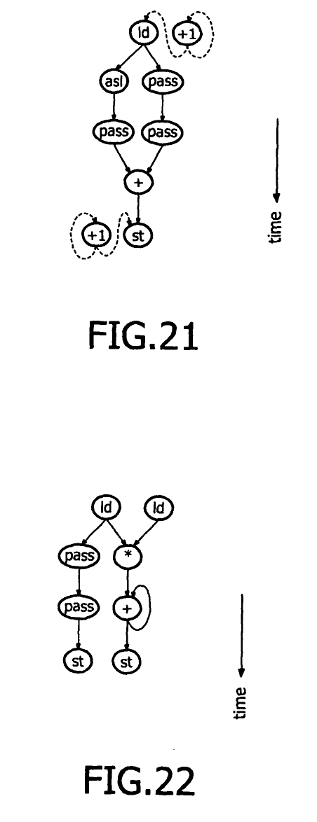

This adapted graph is shown in FIG. 20. Here, a pass operation—as described above—in inserted between the output of a resource supporting the ‘asl’ operation and the input of a resources supporting the add operation. In other words, the graph has been extended with the required pass operation. However, to be able to efficiently fold this schedule into a single instruction loop body, we now have to add two more operations, as shown in FIG. 21.

Please note that the dataflow graph of FIG. 21 is based on the graphs of FIG. 7 and FIG. 10 with the addition of one pass operation in each branch of the dataflow. Therefore, FIG. 21 shows one cascade of two pass operations. According to the principles of the invention the two cascaded pass operations can be replaced by a single pass operation with a latency of 2 cycles, mapped on one resource as described above with respect to the first and second embodiment.

In FIG. 22 a further dataflow graph. Here, again the two pass operations in cascade can be replaced with a single instruction with lower latency, as described above, given that there are enough resources in the architecture

Additionally, pass-operations may be important, since there may not be a direct path between two resources. When an operation that produces some result is assigned to the first resource, and an operation that consumes this result is assigned to the other resource, then no schedule exists, unless there is an indirect path between the units. A resource supplying a “pass” operation may be connected to both resources. Thus, instead of passing the result directly from the producer to the consumer, said third resource, i.e. the pass unit PU provides an alternative path. This is especially important when considering large architectures with many resources. With an increased number of resources and size of the processors, there is also an increase in the number of required pass operations. Even when pass operations are added into a loop, it is desirable to map the resulting loop into a single instruction loop. This may require that one value have to be passed twice or even more. However, this would lead to an increased amount of required functional units supporting the pass operations, which is not desired.

The programmable passing units according to first and second embodiment solve this problem.

These different reasons for introducing pass operations may cascade, increasing the need for pass operations. For instance, introducing a pass operation because there is no direct path may have a negative impact on the lifetime of a variable, such that it needs to be fixed by another pass operation. Thus it may happen that several pass operations need to be executed on the same value.

Preferably, the above-mentioned processor and processing system is a VLIW processor or processing system. However, it may also be some other parallel processor or processing system like superscalar processors or pipelined processors.

Apart from the implementation of the passing operations according to the first and second embodiment, the passing operation may also be implemented on the basis of a rotable register file.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. Parallel processor comprising:
a control means (CTR) for controlling the processing in said processor,
a plurality of passing units (PU) being adapted to perform a programmable number of pass operations with a programmable latency, and
a communication network (CN) for coupling the control means (CTR) and said plurality of first functional units (PU).

2. Parallel processor according to claim 1, wherein each of said passing units (PU) comprises a functional unit (PU) which is adapted to provide a programmable delay.

3. Parallel processor according to claim 2, wherein each of said first functional units (PU) comprises:
a register with a predetermined number of register fields, and
a multiplexer (MP), which is coupled to an input of said first functional unit (PU) for receiving input data and which is coupled to said control means (CTR) via said communication network (CN) for receiving control instruction from said control means (CTR),
wherein said multiplexer (MP) passes incoming data to one of the register fields according to said control instructions received from said control means (CTR).

4. Parallel processor according to claim 1, wherein each of said passing units (PU) comprises:
a plurality of functional units (L0, L1, L2) grouped together in one issue slot,
wherein each functional unit (L0, L1, L2) is adapted to perform a pass operation with a predetermined latency.

5. Parallel processor according to claim 1, wherein said processor is a Very Large Instruction Word processor.

6. Method of parallel processing on the parallel processor, comprising the steps of:
controlling the processing in said processor,
performing a programmable number of pass operations with a programmable latency, and
coupling a control means (CTR) and a plurality of first functional units (PU).

7. A compiler program product being arranged for implementing all steps of the method for programming a processing system according to claim 6, when said compiler program product is run on a computer system.
